(19) United States
(12) Patent Application Publication
(10) Pub. No.: US 2009/0057391 A1
(43) Pub. Date: Mar. 5, 2009

(54) Deposit Container Verification and/or Identification System

(76) Inventors: Don W. Cochran, Gates Mills, OH (US); Fredrick F. Awig, II, Lyndhurst, OH (US); James L. Spayer, Maple Heights, OH (US)

Correspondence Address: Fay Sharpe LLP, 1228 Euclid Avenue, 5th Floor, The Halle Building, Cleveland, OH, 44115-1843, US

(21) Appl. No.: 12/205,734

(22) Filed: Sep. 5, 2008

Related U.S. Application Data
(60) Provisional application No. 60/970,075, filed on Sep. 5, 2007.
(60) Provisional application No. 60/972,126, filed on Sep. 13, 2007.

(51) Int. Cl. G06F 17/00; G06K 7/10

(52) U.S. Cl. 235/375; 235/454

(57) ABSTRACT

A system for identification and confirmation of legitimate deposit refund containers on which a monetary deposit has been collected. The containers include a marking indicating eligibility for collection of the monetary deposit upon return of the containers. The system includes at least one emitter operative to emit radiation positioned to direct the radiation toward a container, at least one sensor operative to sense the radiation reflected back from the container and a control system operative to drive the at least one emitter, receive information from the at least one sensor, and process the information to determine eligibility for the container for the refund of the monetary deposit.

This application claims priority to U.S. Provisional Application Ser. No. 60/970,075, filed Sep. 5, 2007, entitled “Deposit Container Identification System,” and naming Cochran et al. as inventors, and, U.S. Provisional Application Ser. No. 60/972,126, filed Sep. 13, 2007, entitled “Deposit Container Verification and Identification System,” naming Cochran as the inventor, both of which are incorporated herein by this reference in their entirety.

### BACKGROUND

Returnable beverage and beer containers are not new and have been around for decades. An infrastructure formerly existed in the United States which refunded a deposit on refillable containers when returned to a store that was participating. The infrastructure to facilitate this deposit return was quite extensive but was nearly all manual.

As all types of disposable, one-way containers gradually replaced returnable and refillable containers, it became clear that it would be desirable to recycle the containers rather than have them end up as just additional product in the waste stream filling the garbage dumps. The three most popular kinds of beverage and beer containers which consist of glass, PET (polyethylene terephthalate), and metal cans (including both steel and aluminum) are all thoroughly recyclable. Some communities have established recycling programs as part of their garbage collection routines—but most have not. Consequently, either out of inconvenience or laziness, only a relatively small percentage of containers are returned through a typical recycling program.

The manufactures of all three types of containers, both out of solid environmental social responsibility and economics, have been anxious to return back a higher percentage of post-consumer containers for recycling. Some U.S. states have adopted mandatory deposit laws which are intended to dramatically increase the

State deposit laws have proliferated to some states but they have not been enacted in many other states. Because the manufacturers of the containers have resisted the requests to make and segregate containers specifically for, or mark containers specifically for, the deposit law states, a problem exists. Although illegal, people have begun transporting containers from non-deposit states to deposit states. They will then return the containers in the deposit law state to receive a deposit where one has never been paid. For example, Michigan currently charges a $0.10 deposit while the neighboring states of Indiana and Ohio do not charge deposits. This has turned out to be a problem with either the beer and beverage wholesalers or with the grocery store chains, depending on who is handling the money in the transaction. Some business entity is returning a deposit which was never paid. The size of this problem has grown dramatically in the last several years but the container manufacturers and beer and beverage fillers have not agreed on a palatable course of action to verify that the container came from a deposit state where a deposit had actually been paid. The grocery stores are not inclined to police the situation for fear of alienating customers. As this problem has grown in recent years, it has become a very expensive problem.

A solution is needed which entails easily and inexpensively applying some indicator to the container when it is known that it will be sold into a deposit state. Traditionally, if marks are put on the container, they are put on at a substantially early time in the manufacturing process. For example, in two-piece aluminum beverage containers, the two letter abbreviations for each of the states that has a deposit law are incised into the converted end during the metal stamping “conversion” process. A so-called converted end, or completed can end, is manufactured in a complex metal stamping press. Shells (sometimes called lids or ends) which do not yet have a tab, are fed into a transfer system and an indexing belt pocket moves the end to each successive transfer die tooling station. The rivet is gradually formed up from the base material in the center of the end until it is ready to have the tab placed over it. It is then staked to hold the tab in place. Simultaneously, strip tab stock material is coil fed through the side window of the press through its own dedicated multi-out progressive die The output from the tab die is typically three or four completed tabs with each stroke of the press. The tabs are held in the progressive strip until the rivet hole is lined up over the “rivet bulge” in the assembly station of the transfer die. As the transfer die closes, it severs the attachment to the progressive feeding strip and then stakes the rivet to its correct size to hold the tab in place.

If deposit law markings are pressed into the metal by way of embossing or incising or other identifiable geometry, it must be done at or before the afore-described conversion press operation. It has also been proposed in the past to coat the strip stock from which either the end (can lid) is manufactured or from which the tab is manufactured with a UV coating. A UV coating would be defined here as any coating which would fluoresce under a conventional broad-band UV light source. The manufacturing challenge and problem with this approach is that it requires a tremendous amount of tracking and manufacturing discipline. The stamping plant must segregate materials carefully to make sure that the UV coated coils of metal are only used for ends which are destined to a deposit state. Usually, at the time of manufacturing of the converted ends it is not known what its final destination will be. While this sophistication could be added to the manufacturing process, it would be expensive and tedious. There also would be a substantial additional cost factor because it would be expensive to coat the entire surface of the coil stock with the UV coating. It is technologically possible to coat only highly selected portions of the coil but would be an even more cumbersome problem to deal with in the normal converted end manufacturing process. Changing from coated coils to uncoated coils in accordance with the final destination of the product would be a difficult problem for the end-making plant.

Other problems exist with these proposed approaches at the detection end. Currently, there are tens of thousands of automated machines that are part of the recycling stream in the deposit states. Typically, the consumer who is returning cans or bottles will place them one at a time into a receiving portal in what is known as a “reverse vending” recycling machine. After the mechanism inside the “reverse vending” machine (RV) pulls the container in, it rotates the container looking for the bar coded Universal Product Code (UPC) marking. The UPC code is uniform across all states for a given product regardless of whether they are destined for deposit states or not. Using special UPC codes to indicate deposit or non-deposit or to indicate specific states that correspond to specific deposit amounts would add similar complexities to the manufacturing process as were discussed above. To put the marking on the can decoration, it would be necessary to substitute new decorating blankets corresponding to the special UPC code and then to keep the respective cans segregated within the manufacturing and filling and distribution chains. Again, the tediousness of that type of tracking infrastructure has been resisted by the container manufacturers, the fillers of the products, and the distributors.

After the UPC code is read, for example, on a metal can in the RV machine, it is crushed and recorded in the tally in the machine. When the consumer is done introducing containers to be recycled, the machine tallies up the number of containers that have been inserted whose UPC codes indicates that they qualify. It then prints out a voucher which is redeemable for merchandise or cash or other value. The voucher is for an amount consistent with a product of the number of qualifying containers inserted times the deposit amount in the state where the reverse vending machine is located. The RV machine has no way of knowing or detecting that the qualifying UPC coded container came from a deposit state or not. It simply assumes that the container came from the same state in which the RV machine is presently located.

It has been proposed that the reverse vending machines use a broad-band UV light source to trigger fluorescence in a UV coating on the container and then detect it with a sensor. There are several limiting problems with this approach, just as there are problems introduced by it on the manufacturing side. First of all, the conventional broad-band ultra-violet light sources have very limited life, which would be a major maintenance and replacement problem in the tens of thousands of machines that could be deployed in the field. For example, if a fluorescent ultra-violet lamp were used in a machine that had a high duty cycle of usage, it could burn out or be unreliable in less than a year. Specially doped halogen bulbs will typically have an even shorter life span of only a few thousand hours. Xenon bulbs, whether strobed or continuous, would be another choice. They not only have a similarly short life time, but typically require a high-voltage power source which can be another source of unreliability. If not carefully designed, this can also be a safety problem.

A second problem is the relative lack of selectivity that would be afforded by the broad-band UV light sources. Because their wavelength output spans over a considerable band-width, it is not possible to discriminate by using UV fluorescing compounds which must be stimulated with a higher intensity of a specific wavelength in order to be detected. It has further been proposed that a vision system could be employed which is capable of viewing the top of, for example, a beverage can and detecting a particular mark which is embossed or incised into the end. While this is a technologically feasible system, it requires an unnecessary amount of sophistication which brings along its own problems and cost. This is a major consideration in tens of thousands of unsupervised installations in the field. Set-up and adjustment of a vision system or camera-based system is typically more complicated than with simple sensor based systems. As was described above, putting such marks in the container's surface also requires a substantial change to the manufacturing process and infrastructure which is undesirable to the manufacturers of the containers and the fillers of the containers.

### BRIEF DESCRIPTION

In one aspect of the presently described embodiments, a system comprises at least one emitter operative to emit radiation in a first wavelength band selected for use with the marking and positioned to direct the radiation toward a container, at least one sensor operative to sense a second wavelength band of radiation from the container having the marking and a control system operative to drive the at least one emitter, receive information from the at least one sensor, and process the information to determine eligibility for the container for collection of the monetary deposit.

In another aspect of the presently described embodiments, the first wavelength band and the second wavelength band comprise wavelengths substantially the same.

In another aspect of the presently described embodiments, the first wavelength band and the second wavelength band comprise different wavelengths.

In another aspect of the presently described embodiments, the first wavelength band is a narrow band.

In another aspect of the presently described embodiments, the second wavelength band is a narrow band.

In another aspect of the presently described embodiments, the at least one sensor is operative to sense a third wavelength band of radiation from the container having the marking, wherein the marking causes the return of the radiation to the sensor in at least two wavelength bands.

In another aspect of the presently described embodiments, the system further comprises a lens.

In another aspect of the presently described embodiments, the lens is disposed between the container and the sensor.

In another aspect of the presently described embodiments, the emitter is an ultraviolet emitter.

In another aspect of the presently described embodiments, the emitter is an infrared emitter.

In another aspect of the presently described embodiments, the sensor is an RGB sensor.

In another aspect of the presently described embodiments, the control system comprises a microcontroller, an interface to a reverse vending machine controller, and an emitter drive stage.

In another aspect of the presently described embodiments, the microcontroller is operative to communicate with a reverse vending machine controller through the interface and operative to drive the at least one emitter through the emitter drive stage.

In another aspect of the presently described embodiments, the at least one emitter and the at least one sensor are housed within a sensor head.

In another aspect of the presently described embodiments, the sensor head and the control system are housed within a single sensor unit.

In another aspect of the presently described embodiments, the at least one emitter, the at least one sensor, and the control system are positioned within a reverse vending machine.

In another aspect of the presently described embodiments, the at least one sensor is a single sensing element.

In another aspect of the presently described embodiments, a method comprises driving at least one emitter to emit radiation in a first wavelength band selected for use with the marking and positioned to direct the radiation toward a container, sensing through at least one sensor a second wavelength band of radiation from the container having the marking, receiving information from the at least one sensor and processing the information to determine eligibility for the container for collection of the monetary deposit.

In another aspect of the presently described embodiments, the first wavelength band and the second wavelength band comprise wavelengths substantially the same.

In another aspect of the presently described embodiments, the first wavelength band and the second wavelength band comprise different wavelengths.

In another aspect of the presently described embodiments, the first wavelength band is a narrow band.

In another aspect of the presently described embodiments, the second wavelength band is a narrow band.

In another aspect of the presently described embodiments, the method further comprises sensing through the at least one sensor a third wavelength band, wherein the marking causes the return of the radiation to the sensor in at least two wavelength bands.

In another aspect of the presently described embodiments, the emitter is an ultraviolet emitter.

In another aspect of the presently described embodiments, the emitter is an infrared emitter.

In another aspect of the presently described embodiments the first wavelength band of irradiation is one of a wavelength and a wavelength mix such that the marking is not visible to the sensor.

In another aspect of the presently described embodiments, the first wavelength band of irradiation is one of a wavelength and a wavelength mix such that the marking is visible to the sensor.

In another aspect of the presently described embodiments, the first and second wavelength band are in the visible light range.

In another aspect of the presently described embodiments, the marking takes the form of at least one of human and machine readable code.

In another aspect of the presently described embodiments, the marking takes the form of at least one of human and machine readable code.

In another aspect of the presently described embodiments, the marking takes the form of at least one of human and machine readable code.

### BRIEF DESCRIPTION OF DRAWINGS

FIG. 1 is a block diagram of an example system according to the presently described embodiments;

FIG. 2 is a block diagram of an example system according to the presently described embodiments; and,

FIGS. 3(a) and (b) are representative illustrations of an environment into which the presently described embodiments may be implemented.

FIG. 4 is a flowchart illustrating a method according to the presently described embodiments.

### DETAILED DESCRIPTION

The presently described embodiments are directed to a system which facilitates more economical and more flexible coding of deposited containers and whose detection equipment has a number of important advantages. Implementation of the presently described embodiments will allow for convenient and simple modifications to the current process to achieve substantial advantage.

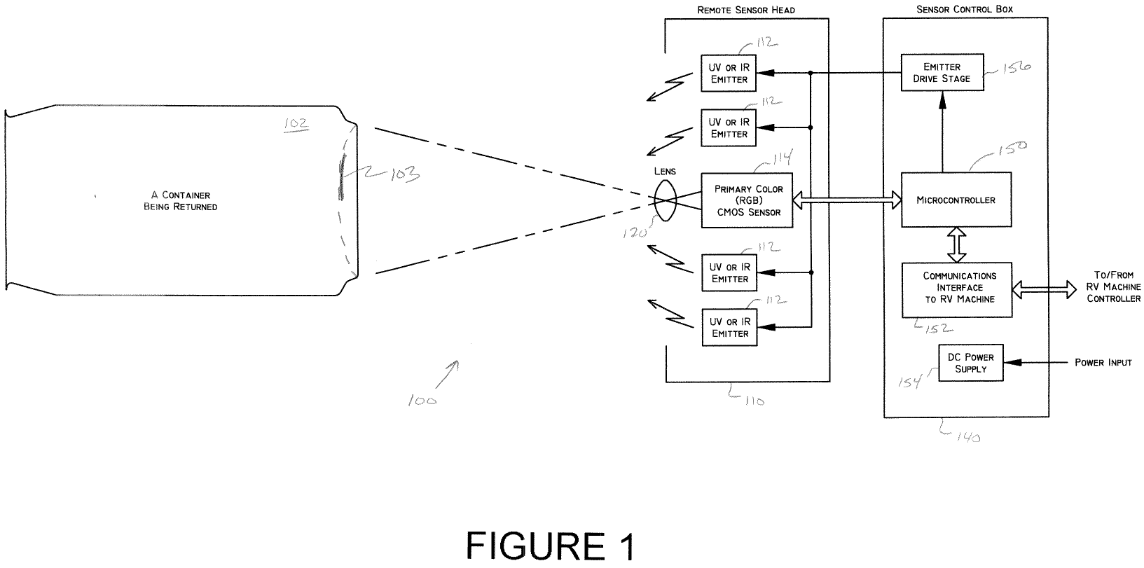

Referring now to FIG. 1, a deposit container verification and/or identification system 100 is illustrated. The system 100, typically implemented within a reverse vending machine, is used to identify markings on containers such as container 102 and verify that the container is eligible for a return of a previously paid deposit. It should be appreciated that the container 102 may take a variety of forms including aluminum or steel cans, plastic bottles, glass bottles, . . . etc. so long as the container is recyclable or otherwise configured to take advantage of the teachings of the presently described embodiments.

The system 100 includes a remote sensor head unit 110 and sensor control box or system 140. The unit 110 may take a variety of forms (including different hardware and/or software configurations) but, in at least one form, includes at least one or a plurality of emitters 112 that may take the form of, for example, ultraviolet (UV) or infrared (IR) emitters operative to emit radiation in selective bandwidths that will suitably irradiate markings (such as that shown at 103 as merely an example) on, for example, the bottom of container 102. The markings may take any desired form, some of which are described herein, including but not limited to human or machine readable code. The selective bandwidths may be narrow bandwidths in some forms. The emitters may take other forms as well.

Also shown within the sensor head unit 110 is a sensor 114. It should be appreciated that sensor 114 may also take a variety of forms but, in one form, is a primary color (RGB) CMOS sensor. These sensors may sense in narrow wavelength bands in some forms. Multiple sensors may also be used; however, to achieve the objectives of robustness and elegance of the presently described embodiments, a single element sensor will be employed—as opposed to a machine vision camera or the like which presently presents an overcomplicated, over-sensitive and over-priced manner to address the needs of the reverse vending industry.

It will also be understood that the sensor 114 may be selected as a function of the types of emitters implemented, or vice-versa. Further, the emitters may emit in one wavelength band and the sensors detect in another wavelength band, or the emitters may emit in the same wavelength band as the sensors detect, or either of the emitters or sensors may operate in a narrow band, all as a function of, among other things, the marking material that is detected. Indeed, in some forms, the marking material may even result in not only detection in a narrow or different band than emission, but it may also result in emission of multiple bands for detection. It should be understood that the wavelength bands contemplated may be in the visible light range or the non-visible range. Also, it will be appreciated that the wavelengths contemplated (such as those emitted by the emitter) may emit in a band or mix such that the marking is visible to the sensor, or is not visible to the sensor.

A lens 120 is also provided to the sensor head 110 so that radiation reflected from the container 102 can be suitably focused on the sensor 114. The lens, likewise, may take a variety of forms, including that of a single lens system, as shown, or a multi-lens system. Also, some systems may not require a lens.

As noted, the control system 140 is also provided to the system 100. It should be understood that the control system 140 may be implemented using a variety of hardware configurations and software techniques that will be apparent to those skilled in the art. For example, some components of the system may be hardware-based while other components are implemented as software routines running on these or other hardware components.

In one form, the control system 140 includes a microcontroller 150 that communicates with a communications interface 152 and is powered by a power supply 154. It should be appreciated that the communications interface 152 communicates with a reverse vending machine controller (not shown) and provides information to the microcontroller 150. Through an emitter drive stage 156, the microcontroller 150 also controls the emitters 112 of the remote sensor unit 110. It should also be understood that the microcontroller 150 further communicates with the sensor 114 so as to obtain information for processing. In this regard, the sensor information is used by the microcontroller 150 to identify markings on the container 102 and determine if the container is eligible for collection of a previously paid deposit. This may be accomplished in any of a variety of manners to achieve the objectives of the presently described embodiments. For example, the size or signal strength for the detected marking cold be evaluated in view of known or normal markings to make this determination as described in more detail hereafter. Other combinations or variations of these techniques may also be used to achieve the objectives herein.

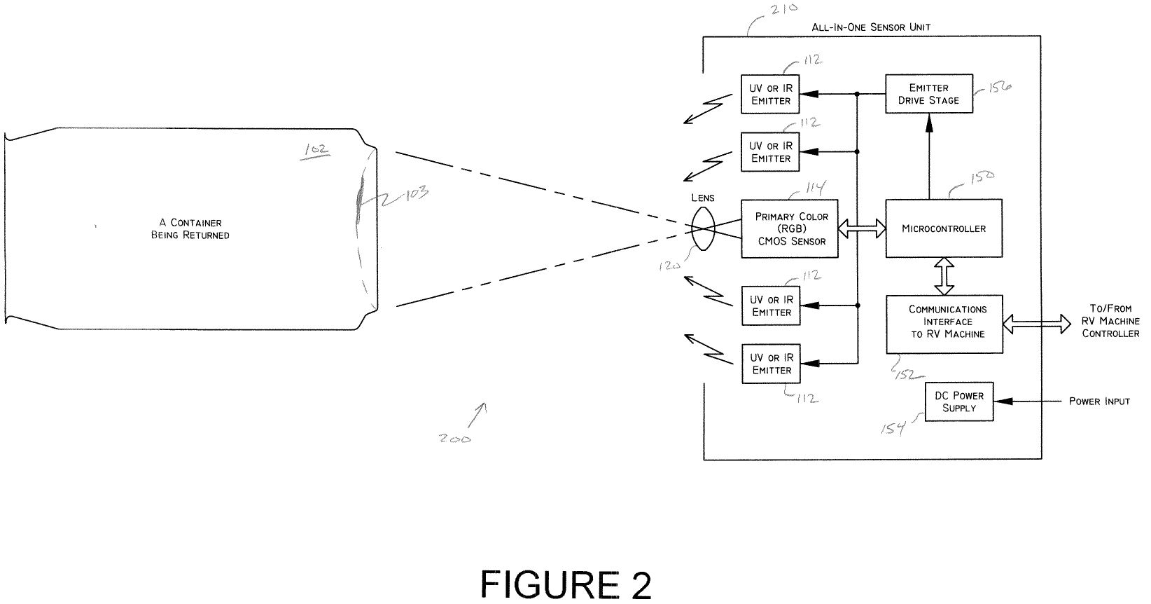

With reference now to FIG. 2, a system 200 is illustrated. The system 200, like the system 100, is provided to identify markings on a container 102 so as to verify that the container 102 is eligible for a return of a monetary deposit. The system 200 is provided with a sensor unit 210. It should be understood that the sensor unit 210, in this form, includes substantially the same components as the sensor head unit 11 0 and sensor control system 140 of FIG. 1. As such, the operation and function of these components is also substantially the same.

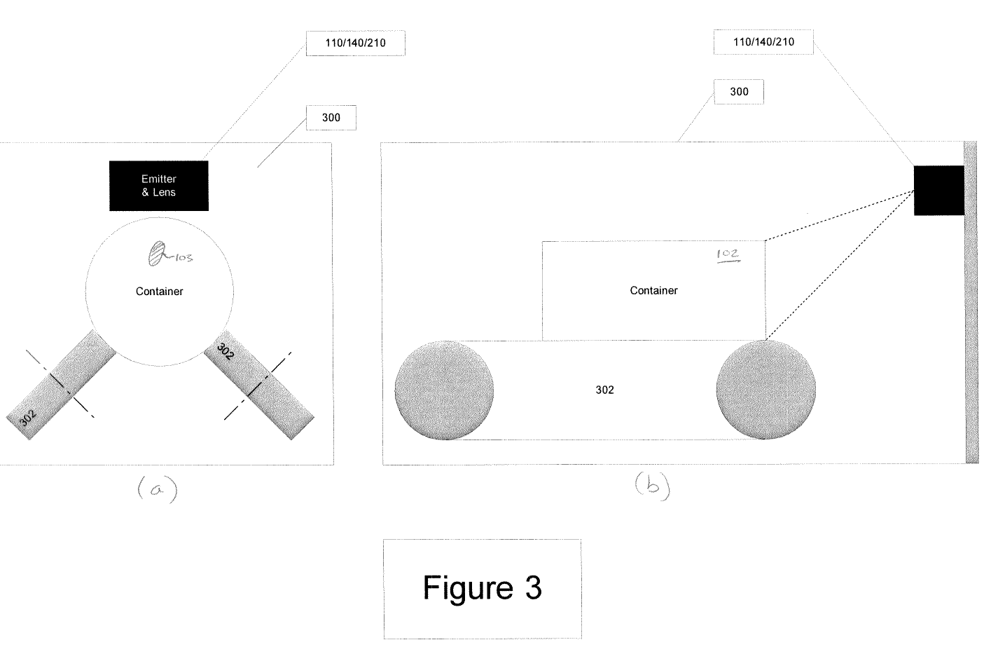

With reference now to FIGS. 3(a) and (b), a system 300 is illustrated. The system 300 is a portion of an exemplary reverse vending machine having a variety of components including, for example, rollers 302. As illustrated, system 300 is an environment into which the presently described embodiments may be incorporated. In this regard, as shown, the sensor head unit 110 and sensor control system 140 and/or the sensor unit 210 may be positioned such that appropriate portions of the container 102 (e.g. those surfaces of the container having suitable markings such as 103 or the like) can be viewed by the system to identify and verify in accordance with the presently described embodiments. The presently described embodiments allow for a convenient retro-fit for the reverse vending machine or a simple add-on in the manufacturing and/or assembly process for the reverse vending machine.

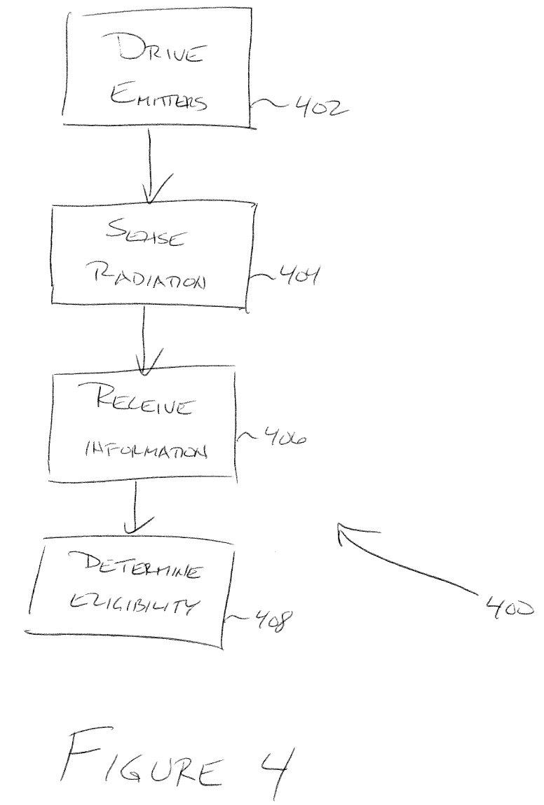

In operation, with reference to the flowchart of FIG. 4, the system 100 or 200 will be triggered to initiate, for example, a method 400 to verify whether a container that has been introduced into the machine has the proper deposit marking. In this regard, the microcontroller will prompt the emitter drive stage to drive the emitters to emit radiation in a first wavelength band selected for use with the marking toward the container (at 402). The sensors will then sense or detect a second wavelength band of radiation from the container having the marking (at 404). Of course, as above, the emitters may emit in one wavelength band and the sensors detect in another wavelength band, or the emitters may emit in the same wavelength band as the sensors detect, or either of the emitters or sensors may operate in a narrow band, all as a function of, among other things, the marking material that is used on the containers and ultimately detected. Also, as above, the radiation may be infrared, ultraviolet, or take on other forms as a function of, among other things, the marking material. The detection or sensing information of the sensors is then passed on to the microcontroller, where it is received (at 406) and processed to determine eligibility for the container for collection of the monetary deposit (at 408).

The system will make this determination and then indicate to the reverse vending machine or other designated element (through a variety of manners including wired or wireless communication) whether the inspected container has the required markings or not. In one form, the circuitry in the control system of the reverse vending machine will then determine what will happen after the go/no-go signal is communicated to it from the present system.

In one form, the system 100 or 200 contemplates utilizing small, sprayed-on “spots” of UV or IR fluorescing compound which can be applied at any desirable point in the container manufacturing, filling, or distribution chain. Various components of this type are available and would meet the objectives of the presently described embodiments. These compounds actually fluoresce with a visible light output component when irradiated with non-visible energy. The non-visible energy could be either in the ultra-violet range or shorter wavelengths than visible light or in the infra-red range of longer wavelengths than visible light, assuming the compound is appropriately formulated for this functionality. These “spots” could be potentially of any shape, whether convenient for the high speed spray applicator or such that the shape was actually indicative of something providing further discrimination.

The system 100 or 200 contemplates using a narrow-band irradiation source which will be extremely long lived. It further contemplates sometimes using narrow-band fluorescing UV or IR compounds which would correspond to the narrow-band irradiation source such that the system is less prone to false triggering or to counterfeiting. It further contemplates sometimes choosing to use more than one narrow band source each of which will be of different wavelengths which will correspond to the specific wavelength fluorescence of the different compounds. By mixing these compounds, which fluoresce at different wavelengths, and utilizing a detection system which irradiates at different corresponding wavelengths to the compounds, it is possible to design a system which has a high degree of resistance to counterfeiting. The more combinations that are used, the higher the overall counterfeiting security level.

The system 100 or 200 will utilize as emitters 112, for example, LEDs, laser diodes, or photon producing transistors as the narrow-band source devices that irradiate in a non-visible portion of the electromagnetic spectrum at a specific center wavelength. The center wavelength of the irradiation source would then be matched to a fluorescing compound which has approximately the same pumping wavelength center. The solid state irradiation devices can be used either singly or in multiple arrays of whatever type is desirable to provide the irradiation intensity, angles, and wavelengths of irradiation desired. If narrow band-width irradiation is desirable (perhaps, 25 nanometers wide) to make the system more secure by providing more selectivity relative to other irradiation and fluorescing compounds, laser diodes may be used. A laser diode will typically have a fraction of the band-width of irradiation as an LED. In this case, it is not being used because of the coherency of the irradiation because this is not important here. The laser diode is being utilized either because it can produce a stronger level of irradiation or because it will typically have a bandwidth that is a fraction of the width of the LED devices. Either type of diode irradiation could provide either strobed or continuous irradiation but would have much longer life if strobed.

Any of a number of ‘off the shelf’ sensors 114 may be used which are sensitive in the desirable band-width range. A system, for example, could comprise of three UV laser diodes 112 each radiating at a different wavelength but generally co-focused in terms of the location that is irradiated. Three corresponding sensors 114 could be deployed to sense for fluorescence from the sprayed-on spot. Each sensor 114 could employ a sharp cut-off band pass filter which will only allow light to be detected in the narrow bandwidth corresponding to that which is pumped by its corresponding laser irradiation source. This assumes that the UV fluorescing spot contains three distinctly different compounds which will fluoresce at different wavelengths.

It may be desirable if the compound that has been selected fluoresces a visible light color, to use some baffling to prevent ambient light from iluminating the spot location during the detection cycle. This makes it more difficult for a counterfeiter to substitute ink or paint of the same visible color as the florescence color. It also will prevent various stray colors that may be on the container from causing a false accept of the container. If the compound spot size is to be very small, it is advised to focus both the irradiation and the field of view of the sensor to a size which will allow good signal to noise discrimination in the detection environment.

Mixing UV fluorescing compounds with IR fluorescing compound could provide another combination which could not be casually counterfeited to ‘beat the system.’ For example, one compound could fluoresce yellow, one blue, and one green. Typically the fluorescing compounds fluoresce in the visible portion of the spectrum but it is also foreseen that compounds could be employed which fluoresce in the non-visible wavelength as long as it is a different wavelength than the irradiation source. This has the additional advantage of requiring special equipment to detect the presence of such compounds which provides for greater security possibilities. Also, since many bars have black lights which put out a substantial amount of broadband UV light, it would make the compounds invisible to the human observer.

In another form, material other than UV or IR material may be used. In this regard, the system 100 or 200 may utilize LEDs, laser diodes, or photon producing transistors as the narrow-band source devices that irradiate in a visible portion of the electromagnetic spectrum at a specific center wavelength. The center wavelength of the irradiation source would then be matched to an ink or color coating which has approximately the same center “color” wavelength. The system contemplates a differentiating between one color of indication marking and another color for the purpose of determining whether a deposit should have been paid or not on the container.

One other implementation is to further sophisticate an ink or coating marking that is currently being added to a container. For example, a “manufacturing or expiration” date is currently ink jetted onto the bottom of a container at the approximate time of filling of the container. This may occur just prior to or just after the actual filling and could be either in the filling machine or just outside the filling machine, but is usually closely associated there with. The “manufacturing or expiration” date is typically a dot-matrix code which is human readable and is often a very readable black or dark blue ink. The current invention contemplates sophisticating the current “manufacturing or expiration” date by making it black, for example, for non-deposit states and an alternate color for deposit states. The invention further contemplates an interaction between the chosen colors of the indication marking and a detection system which would be incorporated into the reverse vending machines.

It is anticipated that the detection system, which is incorporated into the reverse vending machine, would utilize one of several detection methodologies which would increase the robustness of detection while keeping the capital cost reasonable. The detection system would most desirably be an integrated, self-contained system that would include narrow-band illumination, sensor(s), electronic support and logic module, power supply, and an input/output communications module such as that illustrated in FIGS. 1 and 2.

It is also anticipated that the detection system would utilize a narrow-band illumination concept. As alluded to above, the narrow-band source could be one of many devices including LEDs, laser diodes, photon-producing transistors (which are still largely experimental), or other electronically pulsable solid state illumination sources. An alternative narrow-band source could utilize a broad-band illumination source with a narrow-band filter interposed between the source and the target container such that only narrow-band illumination of a chosen wavelength range reached the detection area of the container.

The narrow-band illumination source will be utilized in such a way that it will take advantage of the fact that one color of ink would absorb the narrow-band illumination irradiation while the other color would readily reflect the illumination. The effect is that the ink of the same color as the illumination would disappear or be undetectable on the surface of the container while the ink of the alternate color would absorb the narrow-band illumination and be very detectable. Since there is absorption in one case and reflection in the other, it would create a substantially robust signal differential at the sensor which is deployed to detect the reflection of the illumination. The sensor could be specified as a simple photo cell or could be substantially more sophisticated if desired or required by the application. It could be a CMOS or CCD imaging detector or it could be an RGB type sensor. The narrow-band ilumination can either be continuously “on” during a time when detection is to be preformed or it can be pulsed or strobed only at time of detection. Strobing would stop action and would reduce the effects of vibration, especially when using an imaging chip as the sensor, but would otherwise have similar functionality to continuously on illumination. Strobing also reduces the duty cycle and therefore increases the life of the illumination source which is very desirable in an environment in which an extremely reliable piece of equipment is dictated. The extremely long life is another important reason to use the solid-state illumination source for the contemplated detection system. It is also possible to implement a narrow-band filter in front of the sensor to approximate the similar functionality of rendering the marking of one color undetectable and allowing the marking of another color to be very detectable. The purpose of the narrow-band illumination or narrow-band filters is to dramatically increase the robustness of the detection. It also functions to reduce the ease of counterfeiting for the purpose of trying to beat the system and obtain a deposit return when one is not owed. While the invention can be practiced without the utilization of the narrow-band filter or narrow-band illumination source, it is anticipated that it is the best way of practicing the invention because of the added robustness that can be expected.

While simply disciplining the plant operation to choose one of two or three colors determined by the deposit amount in the intended state is one way of practicing the invention, it is also possible to add another variable which will further reduce counterfeiting possibilities. Either the standard, non-deposit ink or the special, deposit ink could have a fluorescing component added to it (positive logic or negative logic). It's anticipated that the fluorescing additive would require non-visible light, either ultra-violet or infrared, in order to activate the fluorescence. It is also possible to use compounds that fluoresce at another wavelength in the visible spectrum or are stimulated in the visible but fluorescence in the non-visible. If the additional protection of fluorescence were to be added to the method of practicing the invention, the illumination source in the detection sensors would have to be configured accordingly. Typically, an additional sensor would be added which would be specifically for the purpose of detecting the fluorescence wavelength If a narrow-band illumination source Is employed for the other detection, then an additional narrow-band illumination source would have to be added at the fluorescence pumping wavelength of the added compound. If a broad-band illumination source is used in the system which has a broad enough spectrum of irradiation both the primary detection color and the fluorescent compound pumping, then the sensors could simply be equipped with narrowband filters to facilitate detecting their respective wavelengths. Many different combinations and permutations of this concept could be incorporated and/or anticipated as part of this invention but one skilled in the art should be able to take these teachings and implement them into a reliable deposit detection scheme.

The solid state irradiation devices can be used either singly or in multiple arrays of whatever configuration is desirable to provide the intensity, angles, and wavelengths of irradiation desired. If narrow band-width irradiation is desirable (perhaps, 25 nanometers wide), laser diodes may be used. A laser diode will typically have approximately one fourth or less of the band-width of irradiation as an LED. In this case, it is not being used because of the coherency of the irradiation because this is not important here. The laser diode is being utilized because it will typically have a bandwidth that is a fraction of the width of the LED devices and may have more output intensity available at the chosen wavelength. The diode irradiation could provide either strobed or continuous irradiation but would have much longer life if strobed.

Any of a number of ‘off the shelf’ sensors may be used which are sensitive in the desirable band-width range. An RGB, three-color type sensors could be deployed to detect the color of the printing. The sensor could employ a sharp cut-off band pass filter which will only allow light to be detected in the narrow bandwidth corresponding to the ink color.

It is suggested that the last possible opportunity to apply the indicating marking would be at, during, or after the container filling. Often a “manufacturing or expiration” date is ink-jetted onto the domed bottom of the filled container. This date could be applied with the right specification for practicing this invention. For example, the “manufacturing or expiration” dot-matrix date could be applied in black for non-deposit states and in the correct shade of blue for deposit states. The correct color would be 470 nanometers for one such application which would correspond to the narrowband LED illumination source. As the system checks the container, it would detect a different “signal” level if the black ink exists while it would see a much stronger signal returned if the 470 NM blue ink is present. Because the blue ink reflects more of the 470 NM blue light, that has been chosen for this purpose, than the black ink, there is a differential signal level. If the broad-spectrum light, white light, or another color of narrow-band light were used, the signal differential would be substantially less. If the indicating marking represents a very small overall percentage of the surface area, it is advisable to focus both the irradiation and the field of view of the sensor to a size which will allow good signal to noise discrimination in the detection environment. It may also be required or at least recommended that the indicating marking be applied to the container with a very consistent location tolerance.

Also, mixing UV fluorescing compounds or IR fluorescing compounds into the deposit or non-deposit ink could provide a combination which should not be casually counterfeited to ‘beat the system.’ For example, the “manufacturing or expiration” dot-matrix printing could fluoresce yellow while being blue in visible light. One type of sensor would be dedicated to each and would require detection (or non-detection, depending on the logic employed) of both signals before indicating that the container is of the deposit variety. As was mentioned, the fluorescing compounds typically fluoresce in the visible portion of the spectrum but it is also foreseen that compounds could be employed which fluoresce at a non-visible wavelength as long as it is a different wavelength than the irradiation source. This has the additional advantage of requiring special equipment to detect the presence of such compounds which provides for greater security possibilities.

In any of the forms contemplated, the “spot” or marking of fluorescing material or ink can be applied to the container in one of many ways. The assumption is that the compound can be timed or triggered to be deposited onto a surface of the container at a precise time and location. It could be sprayed with an impulse-type spray device. It could be rolled on such that the roller strategically contacted the container for proper application time and location. It could also be ink-jet or electro statically deposited onto the right location on a container. If it is chosen to put the deposit indication marker on earlier in the manufacturing process the converted end transfer die provides a convenient place where an application could be accomplished when the converted end is completely motionless during the metal stamping dwell time. Any convenient place in the manufacturing-filling-distribution chain would be appropriate for practicing this invention. The closest (latest) location to final distribution may prove to be the most optimum from the standpoint of not disturbing the existing container manufacturing infrastructure.

It will be appreciated that the system of the presently described embodiments will also be implemented to be consistent with the location and method of applying the indicating marking to the container and/or the standardization on the specifications of the color or fluorescing compound(s) that will be incorporated.

As has been indicated, the indicating marking can take many forms including being multiple purpose to show information such as manufacturing line or filling date. It is anticipated that the invented concept disclosed herein can be practiced with many different combinations of the thoughts and examples cited and is not limited to the specific applications or implementations communicated herein.

Any simpler or more complex variation on this theme is contemplated by the invention. The system comprised as described above would have many advantages over broadband detection systems.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. An identification and verification system for containers, the containers including a marking indicating eligibility for collection of a monetary deposit upon return of the containers, the system comprising:
at least one emitter operative to emit radiation in a first wavelength band selected for use with the marking and positioned to direct the radiation toward a container;
at least one sensor operative to sense a second wavelength band of radiation from the container having the marking; and,
a control system operative to drive the at least one emitter, receive information from the at least one sensor, and process the information to determine eligibility for the container for collection of the monetary deposit.

2. The system as set forth in claim 1 wherein the first wavelength band and the second wavelength band comprise wavelengths substantially the same.

3. The system as set forth in claim 1 wherein the first wavelength band and the second wavelength band comprise different wavelengths.

4. The system as set forth in claim 1 wherein the first wavelength band is a narrow band.

5. The system as set forth in claim 1 wherein the second wavelength band is a narrow band.

6. The system as set forth in claim 1 wherein the at least one sensor is operative to sense a third wavelength band of radiation from the container having the marking, wherein the marking causes the return of the radiation to the sensor in at least two wavelength bands.

7. The system as set forth in claim 1 further comprising a lens.

8. The system as set forth in claim 7 wherein the lens is disposed between the container and the sensor.

9. The system as set forth in claim 1 wherein the emitter is an ultraviolet emitter.

10. The system as set forth in claim 1 wherein the emitter is an infrared emitter.

11. The system as set forth in claim 1 wherein the sensor is an RGB sensor.

12. The system as set forth in claim 1 wherein the control system comprises a microcontroller, an interface to a reverse vending machine controller, and an emitter drive stage.

13. The system as set forth in claim 12 wherein the microcontroller is operative to communicate with the reverse vending machine controller through the interface and operative to drive the at least on emitter through the emitter drive stage.

14. The system as set forth in claim 1 wherein the at least one emitter and the at least one sensor are housed within a sensor head unit.

15. The system as set forth in claim 14 wherein the sensor head unit and the control system are housed within a single sensor unit.

16. The system as set forth in claim 1 wherein the at least one emitter, the at least one sensor, and the control system are positioned within a reverse vending machine.

17. The system as set forth in claim 1 wherein the at least one sensor is a single sensing element.

18. A method for identifying and verifying containers, the containers including a marking indicating eligibility for collection of a monetary deposit upon return of the containers, the method comprising:
driving at least one emitter to emit radiation in a first wavelength band selected for use with the marking and positioned to direct the radiation toward a container;
sensing through at least one sensor a second wavelength band of radiation from the container having the marking;
receiving information from the at least one sensor; and,
processing the information to determine eligibility for the container for collection of the monetary deposit.

19. The method as set forth in claim 18 wherein the first wavelength band and the second wavelength band comprise wavelengths substantially the same.

20. The method as set forth in claim 18 wherein the first wavelength band and the second wavelength band comprise different wavelengths.

21. The method as set forth in claim 18 wherein the first wavelength band is a narrow band.

22. The method as set forth in claim 18 wherein the second wavelength band is a narrow band.

23. The method as set forth in claim 18 further comprising sensing through the at least one sensor a third wavelength band wherein the marking causes the return of the radiation to the sensor in at least two wavelength bands.

24. The method as set forth in claim 18 wherein the emitter is an ultraviolet emitter.

25. The method as set forth in claim 18 wherein the emitter is an infrared emitter.

26. The method as set forth in claim 18 wherein the first wavelength band of irradiation is one of a wavelength and a wavelength mix such that the marking is not visible to the sensor.

27. The method as set forth in claim 18 wherein the first wavelength band of irradiation is one of a wavelength and a wavelength mix such that the marking is visible to the sensor.

28. The method of claim 26 wherein the first and second wavelength band are in the visible light range.

29. The method of claim 26 wherein the marking takes the form of at least one of human and machine readable code.

30. The method of claim 26 wherein the marking takes the form of at least one of human and machine readable code.

31. The method of claim 27 wherein the marking takes the form of at least one of human and machine readable code.
